(19) United States
(12) Patent Application Publication
(10) Pub. No.: US 2016/0195063 A1
(43) Pub. Date: Jul. 7, 2016

(54) METHOD FOR PRODUCING A COMPOSITE MOLDED PART, COMPOSITE MOLDED PART, SANDWICH COMPONENT, ROTOR BLADE ELEMENT, AND WIND TURBINE

(71) Applicant: WOBBEN PROPERTIES GMBH, Aurich (DE)

(72) Inventor: Alexander Hoffmann, Emden (DE)

(21) Appl. No.: 14/909,880

(22) PCT Filed: Jul. 11, 2014
(86) PCT No.: PCT/EP2014/064955

§ 371 Date: Feb. 3, 2016

(30) Foreign Application Priority Data
Aug. 5, 2013 (DE) 10 2013 215 384.8

(51) Int. Cl. F03D 1/06; B29C 47/00; B29C 47/02; B29C 70/22

(52) U.S. Cl. CPC F03D 1/0675; B29C 70/222; B29C 47/0014; B29C 47/022; B29K 2101/12

(57) ABSTRACT

A composite molding, in particular manufactured according to a method according to the invention, in particular for a wind-energy installation, having a thermoplastic material and a fiber-composite semi-finished product. It is furthermore provided according to the invention that the fiber-composite semi-finished product has a flexible, braided formation-type fiber system, the thermoplastic material, as a shape-imparting core material, is distributed in the flexible, braided formation-type fiber system of the fiber-composite semi-finished product and is connected to the braided formation-type fiber system, wherein the braided formation-type fiber system in the composite with the shape-imparting core material has mutually intersecting fibers which are oriented in relation to one another and which, in an intersection point, have a fiber angle which is between 10° and 90°, which in particular is between 30° and 60°, the fibers preferably being oriented at a fiber angle around 45° with a variance range of +/−5°, and wherein the braided formation-type fiber system in the composite forms the outer functional layer of the composite molding.

### BACKGROUND

1. Technical Field

Method for manufacturing a composite molding, in particular for a wind-energy installation, having a thermoplastic material and a fiber-composite semi-finished product. The invention furthermore relates to a composite molding, a sandwich component, a rotor-blade element and a wind-energy installation.

2. Description of the Related Art

Composite moldings are moldings of two or more interconnected materials which are manufactured as a body and have fixed geometrical external dimensions. The materials appearing in the composite mostly have functional properties which, in particular, are tied to their field of application. For the properties of the material obtained, material properties and, in some circumstances, also geometrical properties of the individual components are of significance. This makes it possible for properties of different components to be interconnected, on account of which the composite materials find a wide range of application possibilities. The properties required for the final product may be set according to requirements by way of selection of various primary materials for the components.

A composite component mostly has properties which, under a load effect, represent an optimized behavior of the composite molding. The properties may be assigned to, for example, a particular strength, rigidity or ductility. Under a load effect, a composite molding should represent an optimized behavior of the composite in relation to a single component of the composite. The development of composite moldings is fundamentally directed towards optimizing the required properties in combination with service life, in order to withstand stress over many years. High and very variable load effects are exerted in particular on rotor blades and other parts of a wind-energy installation, said load effects moreover likewise increasing with the increasing size of a part of a wind-energy installation. In particular rotor blades should withstand the static loads as well as the dynamic loads which arise.

Therefore the rotor blades of the wind-energy installations today are mainly composed of fiber-composite materials in which reinforcing fibers, mostly as mats, are embedded in a matrix, mostly glass fiber-reinforced plastic. A rotor blade is mostly manufactured in a half-shell sandwich construction technique. Carbon fiber-reinforced plastic, for example, is being increasingly employed. The properties required here are, on the one hand, light weight at comparatively high structural strength, and various degrees of hardness and a tensile strength which is oriented towards the load effect. With respect to their optimized strength, glass fiber-reinforced and/or carbon fiber-reinforced materials could, in any case in principle and from the abovementioned viewpoints, take the place of balsa wood previously employed.

Fiber-reinforced components or composite components have fibers which are distributed in a laminate material, wherein the fibers are oriented in at least one specific direction in order to achieve the superior property of the fiber-composite material. In any case, three effective phases may be differentiated in principle in the material: high-tensile fibers, an embedding matrix which is, in any case initially, comparatively soft, and a barrier layer which interconnects the two components. The fibers may typically be composed of glass, carbon, ceramic, but also of aramid, nylon fibers, concrete fibers, natural fibers or steel fibers. The embedding matrix itself, mostly polymers, has a material-specific flexural rigidity, holds the fibers in position, transmits tensions between the fibers, and protects the fibers against external mechanical and chemical influences. The barrier layer serves for transmitting tension between the two components. In the case of fiber-reinforced composite components potential crack formation of the respective fibers in the stressed regions of the component are problematic; the former may be created as a result of above all increased dynamic mechanical stress.

However, fiber-reinforced components or composite components having in each case a specific number of fibers in a laminate material or matrix material significantly improve the mechanical performance of the respective components. For material-specific characteristics, such as shear rigidity and flexural rigidity and the concentration of the fibers in a defined direction, the mechanical support properties of the respective components can be individually set in a targeted manner, in particular in relation to the tensile strength of the respective composite. One factor for dimensioning fiber-composite materials is the volume ratio of fibers to matrix. The composite material becomes stronger, but also more brittle, the higher the proportion of fibers. Apart from tensile strength, shear rigidity and flexural rigidity may also play a role if the composite is subjected to compression. It is, in particular, moreover known in principle that high mechanical rigidity of the composite may be achieved by way of a so-called sandwich-type composite construction having a core and one or two cover layers, following the principle of a T-beam, by means of a core having moderate shear rigidity and at least one cover layer having comparative flexural rigidity, wherein the composite may nonetheless be implemented in a lightweight construction technique.

Rotor blades of a wind-energy installation are typically constructed from fiber-reinforced components, mostly with mainly glass fibers and/or carbon fibers in a resin-type laminate matrix material. Such or other fibers may be oriented in or along the longitudinal axis of the rotor blade, wherein the exact orientation of the fibers is mostly difficult to control. However, a rotor blade may, in principle, be optimized with respect to the centrifugal forces and/or gravitational forces which are applied during operation. Orientation of the fibers may indeed be influenced depending on the manufacturing process. It may be decisive here which types of fiber semi-finished products are used; these may comprise fabrics, laid webs, mats, rovings, but also filling materials, particles, needles or pigments. The methods for manufacturing the fiber-composite component are manifold. Presently methods comprising manual lay methods, prepreg technologies, vacuum-infusion methods, fiber-wrapping methods, injection-molded parts, fiber injection, transfer-molded parts, extrusion-molded parts and sheet-molding compounds (CMC) are known. Injection-molded parts, for example, are manufactured by way of the cost-effective injection-molding method in which glass fibers are typically employed.

DE 103 36 461 describes a method for manufacturing a rotor blade in a fiber-composite construction technique in which shells which form the outer contour of a rotor blade are manufactured, and the supporting structures are manufactured from fiber strands which have a predetermined length and which were correspondingly impregnated with a curing composite material, and the supporting structures are transported in the shells.

U.S. Pat. No. 4,242,160 discloses a method in which a one-part fiber-reinforced rotor blade is composed of bonded inner and outer shells which are fiber-reinforced. The inner casing is manufactured by connecting separately configured, tubular halves. The outer shell is constructed on the outside of the inner shell, preferably by wrapping thereon a multiplicity of windings of fiber-reinforced epoxy-resin material.

The fiber-wrapping method guarantees a high degree of accuracy for positioning and orienting the fibers, in particular as a technology for depositing continuous fiber strands (rovings) which, via further method steps, are impregnated and cured, onto a shape which is at least almost cylindrical. The body of the component for wrapping the fibers is the later shape of the fiber-composite material. In the case of fiber wrapping a differentiation is additionally made between lost cores and recyclable cores, wherein the lost core may be a functional component of the design.

US 2012/0261864 discloses a method in which, similar to a negative image of a fiber-reinforced structure to be manufactured, a fiber material is laid onto the surface of the shape. The bundles of the fiber material here are placed and oriented on the surface in such a manner that provision of a fiber-reinforced structure is established by applying low compression.

In the case of a high-performance composite structure, fiber preforms are injected with resin and cost-effective fiber preforms which are suited to stress for continuous fiber-reinforced composite components are manufactured. These preforms are tailored in the sense of fiber orientations which are suited to stress, local fiber accumulations which are suited to stress, and outer contours. The preforms thus manufactured may be processed into components in the so-called autoclave-prepreg construction technique, using conventional productions processes.

The German Patent and Trademark Office, in the priority application, has researched the following prior art: DE 43 00 208 A1, DE 103 36 461 A1, DE 10 2012 201 262 A1, EP 0 402 309 A1, EP 0 697 275 A2, EP 0 697 280 A1, EP 1 992 472 A1, and WO 94/19176 A1.

### BRIEF SUMMARY

One or more embodiments are directed to an improved method for manufacturing a composite molding, a composite molding and a sandwich component, a rotor-blade element and a wind-energy installation. One or more of the embodiments may provide an improvement with respect to the prior art. At least an alternative solution to a solution known in the prior art is to be proposed. In particular with respect to the manufacturing method, a simple and controllable possibility of manufacturing a composite molding is to be offered. In particular, at least one optimized property of the composite molding with respect to the static and dynamic stresses is to be illustrated. The manufacturing method and the composite molding are to counteract the applied forces in an improved manner, in particular with oriented and accordingly aligned fibers. Moreover, the manufacturing method and a composite molding and/or a sandwich component, a rotor-blade element, and a wind-energy installation are to use an optimized layer system which, in terms of process technology and/or being material-specific, make possible improved functioning. The composite component and the method are to make possible, in particular, long-term rigidity and/or strength directed towards the load effects, preferably while increasing both flexural rigidity and shear rigidity.

A method for manufacturing a composite molding, in particular for a wind-energy installation, having a thermoplastic material and a fiber-composite semi-finished product, wherein the method has the following steps:
providing the thermoplastic material and the fiber-composite semi-finished product having a flexible, braided formation-type fiber system,
distributing the thermoplastic material as a shape-imparting core material in the flexible, braided formation-type fiber system of the fiber-composite semi-finished product, and connecting the former to the braided formation-type fiber system, wherein
the flexible, braided formation-type fiber system in the composite with the shape-imparting core material has mutually intersecting fibers which orient themselves in relation to one another, and
which, in an intersection point, have a fiber angle which is between 10° and 90°, which in particular is between 30° and 60°, the fibers preferably orienting themselves in relation to one another at a fiber angle around 45° with a variance range of +/−5°, and wherein
the braided formation-type fiber system in the composite forms the outer functional layer of the composite molding.

The fibers preferably orient themselves in relation to one another at a fiber angle around 45° with a variance range of +/−5°.

A composite molding, in particular manufactured according to the aforementioned method, in particular for a wind-energy installation, having a thermoplastic material and a fiber-composite semi-finished product is provided. It is provided that
the fiber-composite semi-finished product has a flexible, braided formation-type fiber system,
the thermoplastic material, as a shape-imparting core material, is distributed in the flexible, braided formation-type fiber system of the fiber-composite semi-finished product and is connected to the braided formation-type fiber system, wherein
the braided formation-type fiber system, in the composite with the shape-imparting core material, has mutually intersecting fibers which are oriented in relation to one another,
which fibers, in an intersection point, have a fiber angle which is between 10° and 90°, which in particular is between 30° and 60°, the fibers preferably being oriented in relation to one another at a fiber angle around 45° with a variance range of +/−5°, and wherein
the braided formation-type fiber system in the composite forms the outer functional layer of the composite molding.

A braided formation-type fiber system is to be understood in principle in a wide sense as any type of a strand system which has a specific variability with respect to intersecting fibers which are oriented in relation to one another. This is preferably a braidwork or braided structure in which a plurality of strands of bendable, and if comprising such flexible material, fiber material interlace, or a knit in which bendable, and if comprising such flexible material, fiber material interlaces with itself; loop-forming thread systems, such as warp knits, are also possible. Moreover fabric-type structures in which the strands are guided entirely or partially perpendicularly or close to 90° in relation to one another, are, however, less preferable but possible, preferably having, in an intersection point, a fiber angle which is preferably between 10° and 90°, which is preferably between 30° and 60°, the fibers preferably being oriented in relation to one another at a fiber angle around 45° with a variance range of +/−10° and/or in another specific fiber angle orient themselves in relation to one another with a variance range of +/−5°.

Accordingly, in particular those types of strand systems of which the fiber angle can moreover be variably set, in particular is automatically variably set, depending on the size and shape of the shape-imparting core material to be introduced, are particularly preferred. Accordingly a flexible and variably shapeable, braided formation-type fiber system having a variable fiber angle is particularly preferable. Certain fiber systems support this property particularly well, such as, for example, in particular a braided formation-type fiber system which is selected from the group which is composed of braidwork, knits, warp knits.

The sandwich component includes at least one, in particular a multiplicity of composite moldings for forming a core component. The core component is at least on one side, preferably on two sides, covered by at least one cover layer. In a refinement the core component of the sandwich component is covered with force-absorbing cover layers which, by way of a core material of the core component, are kept at a distance. The present refinement make it possible for the aforementioned combination of properties having finite maximal values to be integrated, while maintaining a light weight, into a sandwich component which overall lastingly counteracts in the case of comparatively high load effects, mostly a linear increase of the nominal values. The sandwich component, on account of the braided structure-type fiber system which in the composite with the shape-imparting core material has mutually intersecting fibers which orient themselves in relation to one another and which, in an intersection point, have a fiber angle which is between 30° and 60°, the fibers in particular orienting themselves in relation to one another at a fiber angle around 45° with a variance range of +/−5°, in particular has improved shear rigidity and flexural rigidity.

In a preferred refinement the rotor-blade element includes at least one, in particular a multiplicity of composite moldings as a core material. This refinement integrates an optimized composite molding into a rotor blade, in particular into a half-shell of the latter in the manufacturing process; on account thereof improved lasting strength, in particular an improved compressive strength and/or improved shear rigidity and flexural rigidity can be achieved. In this manner the rotor blade is optimized with respect to the centrifugal forces and/or gravitational forces which are applied during operation. By way of use of this composite component crack minimization and/or minimized crack propagation is achieved on account of the shape-imparting core being a thermoplastic material.

A wind-energy installation has a tower, a nacelle, and a rotor with a rotor hub and a number of rotor blades, wherein the rotor blade has at least one rotor-blade element and/or the tower, the nacelle and/or the rotor hub has a sandwich component.

Since, on account of the ever increasing dimensioning of the rotor blades, ever higher loads are to be expected also for the structural-dynamic behavior of the rotor blades, this may be counteracted by way of the material-specific characteristics of the composite component.

In principle, one or more embodiments of the invention comes to bear in general in a composite molding, also independently of the manufacturing method. However, in particular a composite molding which is manufactured according to the manufacturing method according to the concept of the invention has proven advantageous. However, in principle other methods than the claimed manufacturing method may also be used for manufacturing.

A fiber-composite material as described in the prior art may counteract the load effect. Increased requirements in relation to a composite component and/or increased geometrical dimensioning of specific composite components, such as, for example, rotor blades, necessitate a new approach to a composite component, wherein resources and efficiency have also to be considered in a manufacturing method. In particular, increased flexural rigidity and shear rigidity are achieved in the composite molding with the braided formation-type fiber system in the composite with the shape-imparting core material, since said fiber system has mutually intersecting fibers which orient themselves in relation to one another and which, in an intersection point, have a fiber angle which is between 30° and 60°, the fibers preferably orienting themselves in relation to one another at a fiber angle around 45° with a variance range of +/−5°.

In accordance with the type of a fiber-matrix composite component, strength and rigidity are significantly higher in the direction of the fibers in the composite molding than transversely to the direction of the fibers. Since the effect of the loads, such as traction or compression, does not, however, always occur perpendicularly to the surface normal, the effect of fibers which are oriented in only one direction in the fiber-composite component would be rather limited. A functional orientation of mutually intersecting fibers that minimizes the effect of force and/or load on the component in the surface is provided. To this end it is provided that the intersecting fibers orient themselves in relation to one another and, in an intersection point, have a fiber angle which is between 30° and 60°, the fibers preferably orienting themselves in relation to one another at a fiber angle around 45° with a variance range of +/−5°.

On account of the fibers which orient themselves variably with respect to one another, it is possible for the method, with which this oriented composite molding is manufactured, to be carried out in a technically simple and cost-effective manner.

The functional orientation makes it possible for a load-oriented composite molding to be manufactured which experiences the method of distributing the shape-imparting core material and makes possible the configuration of an outer layer as a functional layer. This layer distinguishes itself as a functional layer, since, on account of the functional orientation of the fibers, it counters the load effect. The oriented fiber-layer arrangement of mutually intersecting fibers leads to a constructive increase of the mechanical properties and may correspond to the requirements on a composite molding.

One or more embodiments are based on the consideration that a settable rigidity is possible by way of the selection of a suitable, flexible braided formation-type fiber system and composing the latter with the thermoplastic material. Ductile properties of the matrix—the thermoplastic material—as a shape-imparting core material are combined here with the properties of the outer functional layer—the composed braided formation-type fiber system which is composed so as to be functionally oriented—which, above all, increase strength, in particular breaking strength.

Advantageous refinements may be obtained from the dependent claims and individually indicate advantageous possibilities for the concept explained above to be implemented within the scope of the definition of the object and also with respect to further advantages.

A particularly preferred refinement is based on the consideration that by use of a flexible, braided formation-type fiber system of a fiber-composite semi-finished product a directionally-oriented braid, loop, warp-knit or similar structure can be set which—in particular when introducing a matrix or a similar shape-imparting core material, in particular in the manufacturing method—can orient itself in a manner corresponding to the shape of the core material, in order to thus set in a relevant manner the functional layer on the core material, may be provided. This is the case in particular with a shape-modifiable, braided formation-type fiber system having a braid, loop, warp-knit or similar fiber structure, wherein, when modifying the shape thereof, in the intersection point, an each in case modifiable fiber angle is created in the braid, loop, warp-knit or similar fiber structure, which fiber angle may be between 10° and 90°, which in particular may be between 30° and 60°, in particular may be between 40° and 50°, in particular in which the fibers orient themselves in relation to one another at a fiber angle of around 45° with a variance range of +/−5°. In particular in the case of a tubular two-dimensional or three-dimensional, braid formation-type fiber system this leads to an expandable variable cross section, such that, when introducing the shape-imparting core material, the entire structure is expandable, ductile and contractible, independently of any potentially bendable or flexible fiber material. Opening cross sections which are expandable in the range of at least 2:1 up to 6:1, in particular in the range of 4:1, are advantageous, in particular in the case of a braided tube or a fabric tube.

On account of selection of the oriented fiber-layer arrangement and of the fibers that has been left to be self-settable per se, the rigidity and or compression resistance of the outer layer can be influenced. The refinement in particular also makes possible a method which is cost-effective, is controllable, and moreover makes possible an improved implementation of a functional composite molding. On account of the mutual reciprocal effects, in particular shapes which mutually adapt themselves, of the two components core material and braided formation-type fiber system and the correlations between them, the composite component experiences a particularly optimized combination of properties in order to achieve a long service life under static and dynamic load effects.

A further advantage lies therein that, on account of the combination of two materials in the core material and braided formation-type fiber system, specific material characteristics may be set; the two materials can be independently optimized in relation to one another. The matrix thus represents only the inner core, without having to accommodate additional further functions, such as anchoring, erosion protection and corrosion protection.

In contrast to the hitherto usual application of fiber-composite materials, here the fiber is the outer functional layer which covers a shape-imparting core. Here, this functional layer protects the core and thus expands the potential product portfolio of the thermoplastic materials in the direction of less resistant types. Since the matrix component only represents the bearing surface as a shape-imparting core, by way of the diameter of the core that is in each case set the proportion of the specific material properties may be modified.

The braided formation-type fiber system may counteract the respective load effect, which mostly varies locally due to component issues, in a specifically local manner by way of the selection of the fibers, the local density and a combination of various fibers. By way of the corresponding density and the barrier layer configured in the composite a protective layer and simultaneously a force transmission to the interior of the core may be created.

The method may be particularly advantageously illustrated by way of the functional mutual orientation in the 45° angle, since the orientation in a parallelogram of forces is oriented counter to the acting load. The mechanism here is based on the consideration that the normal components of the force proportions acting horizontally and vertically are divided up in a parallelogram. The orientation of the fibers is thus oriented counter to the acting force and/or load.

On account of the orientation by way of the preferred 45° fiber angle at the intersection point or another suitable fiber angle, an increased acting load can be absorbed on the surface, or can be accordingly counteracted, respectively. At the same time, the preferred 45° angle and/or the orientation of the braided formation-type fiber system at the 45° angle can be seen in this light as ideal for achieving particularly high torsion strengths and/or shear strengths.

In a preferred refinement a composite molding is manufactured according to the method described above, wherein a thermoplastic material as shaped-imparting core material is distributed and connected in a flexible, braided formation-type fiber system of a fiber-composite semi-finished product, wherein the braided formation-type fiber system when composed with the shape-imparting core has fibers which are functionally oriented in relation to one another at the fiber angle between 30° and 60° and wherein the oriented, braided formation-type fiber system in the composite represents an outer functional layer of the composite molding. The composite molding of the preferred refinement in particular has a functional orientation at the angle of 45°. The refinement thus offers a composite molding which is comparable to fiber-composite components, however in this case having a functional orientation in relation to the outer layer that thus has the effect of an oriented strength. The oriented fibers at an angle between 30° and 60° and/or preferably at an angle of 45° have the effect that the load effect, in this case traction or compression, is contained in a micromechanical manner by the opposing forces of the parallelogram of forces. Moreover, the initially flexible, braided formation-type fiber system makes possible large variations of the shape-imparting core material. In this case, a manufacturing process is no longer linked to the technical implementation of the fiber-composite component but may adapt the shape of the core in a manner corresponding to the application. By way of the refinement, a functional molding which, in its shape, is arbitrary has been developed. The protecting fiber of the fiber-composite semi-finished product is tightly composed with the shape-imparting thermoplastic material, having functional properties which are composed of the material characteristics of the thermoplastic material and of the flexible, braided formation-type fiber system. This composite molding, on account of the braided formation-type fiber system, moreover has an additional function, i.e. the oriented counteraction with regard to specific loads.

In a preferred refinement a thermoplastic material is distributed and connected in a materially-integral manner in the flexible, braided formation-type fiber system of the fiber-composite semi-finished product; this offers the possibility that the components the thermoplastic material and the fiber-composite semi-finished product may connect to one another in a chemically adhesive or cohesive manner. The effect achieved thereby is an optimized layer system which can more easily distribute the forces acting thereon, since a smaller boundary surface for easier transmission of surface forces is configured via a materially-integral composite. The components are held together by atomic or molecular forces. They are thus unreleasable connections which may only be separated by destroying the connection means. A materially-integral connection has the effect of a composite which does not experience further forces in the case of a load effect. On account of the composite, the outer functional layer—the oriented, braided formation-type fiber system—may effectively display its manner of function. The refinement may mean an additional component in the braided formation-type fiber system that causes the exclusive materially-integral connection or the individual fibers may internally include the materially-integral connections. In this manner, impregnated fibers of the flexible, braided formation-type fiber system may also facilitate this materially-integral connection. Alternatively, vacuum-infusion manufacturing would also be conceivable. This materially-integral connection proves advantageous with respect to aggressive corrosive and abrasive media.

A preferred refinement provides that the thermoplastic material is distributed and connected in a form-fitting manner in the flexible, braided formation-type fiber system of the fiber-composite semi-finished product; the refinement makes possible a form-fit between the thermoplastic material and the fibrous semi-finished product. Here, the shape-imparting core may already have surface cavities. The cavities here have to be designed in such a manner that the counter force of the outer layer is not exceeded by forces acting thereon, in order to release the composite again from its form-fit. At the same time it would also be conceivable that, in this refinement, the thermoplastic material is distributed in such a manner that the flexible, braided formation-type fiber system can sink in and is penetrated. On account thereof mechanical anchoring, which in this case represents the form-fit, is made possible. The combination of a materially-integral and a form-fitting composite unifies both positive aspects and is conceivable on account of this refinement.

In a particularly preferred refinement the thermoplastic material is extruded into the flexible, braided formation-type fiber system of the fiber-composite semi-material. The method preferably has the steps of making available the thermoplastic material as a strand, in particular from an extruder, and the flexible, braided formation-type fiber system is made available as a tubular, braided-formation type fiber system. It is preferably further provided that the thermoplastic material, as a shape-imparting core material, is distributed in the flexible, braided formation-type fiber system of the fiber-composite semi-finished product in that it is introduced, in particular extruded, as a soft strand, in particular from the extruder, into the tube of the braided formation-type fiber system, and said thermoplastic material, as an outer functional layer of the composite molding, while solidifying the soft strand, forms a composite with the braided formation-type fiber system.

The refinement offers the possibility that a thermoplastic material as a shape-imparting core material is forced into the flexible, braided formation-type fiber system and distributes itself therein. It is also conceivable that a strand of a solid to viscous thermoplastic compound is continuously squeezed under pressure out of the shape-imparting opening into the flexible, braided formation-type fiber system of a fiber-composite semi-finished product. Here, a corresponding body of theoretically arbitrary length is created at the shape-imparting opening and may thus correspondingly orient the flexible, braided formation-type fiber system. The cross section of the opening here is adaptable, corresponding to the diameter of the braided formation-type fiber system, and makes possible orienting the flexible, braided formation-type fiber system by drafting or stuffing the flexible, braided formation-type fiber system towards the functional orientation of the fibers in the composite.

Extrusion technology is per se a known method which, however, moreover may be used in a synergetic manner to introduce, in particular extrude, the soft strand, in particular from the extruder, into the tube of the braided formation-type fiber system, that is to say directly from the extruder.

This moreover allows easy implementation which allows a controllable and cost-effective variant for manufacturing the composite molding which is functional in a layer system. The use of the extrusion method for the corresponding composite molding moreover makes possible the implementation of complex shapes which can be simultaneously implemented by being squeezed into the flexible, braided formation-type fiber system. The orientation of the fibers may be performed by the molded formation itself. This refinement ultimately also makes possible a method at comparatively high temperatures that are favorable to the composite, be it a materially-integral and/or a form-fitting one.

On account of additional fibers in the two-dimensional formation, a preferred refinement increases strength in particular moreover flexural rigidity and shear rigidity, of the composite molding, independently of the angle. This refinement considers that the functional orientation counteracts the parallelogram of forces of the load effect; however, in the case of further forces and/or of forces acting in various manners, further threads which run in a different direction may absorb additional forces and increase rigidity and/or strength of the composite molding. The manner of function of the outer layer of the composite molding is thus optimized with respect to the forces applied thereto and has a greater tolerance in relation to the forces acting thereon. At the same time, this refinement, on account of bundling additional threads, also made possible higher rigidity on the edges and/or corners of the composite molding. The orientation of the fibers moreover may be controlled by additional fibers and compacts the functional layer formed by the braided formation-type fiber system.

A braided formation-type fiber system in the shape of a tube preferably has a two-dimensional braided structure. This refinement makes possible the form-fitting composite without edge effects or gap effects in the outer functional layer. Weak spots in the outer functional layer may be minimized by the shape of a tube and in the manufacturing method simultaneously make possible a simple process step of uniform distribution and the homogenous orientation of the composite component with the outer functional layer.

A preferred refinement is that the braided formation-type fiber system has the shape of a tube with a three-dimensional braided structure and has additional fibers in the interior of the composite that are functionally oriented in relation to one another at the fiber angle between 30° and 60°, preferably 45°. This refinement picks up on an additional aspect which is already implemented in the fiber-composite materials, i.e. that internal structures involve additional strength. By acquiring a three-dimensional braided structure, functional forces may also be generated from the interior of the matrix of the shape-imparting core material. Orientation of the fibers is, in principle, possible in the widest variety of shapes; however, absorbing a load is preferred at a fiber angle in the range of 45°+/−5°; this angle is particularly suited to high torsion forces and/or shear forces. The refinement additionally makes it possible for the thermoplastic material to be optimized in its material-specific property with respect to the forces acting thereon, without additional weight being involved. Here, above all materially-integral composite possibilities are conceivable.

In a particularly preferred refinement the thermoplastic material is at least one component from the group of acrylonitrile butadiene styrene, polyamide, polyacetate, polymethyl methacrylate, polycarbonate, polyethylene terephthalate, polyethylene, polypropylene, polystyrene, polyether ether ketone and polyvinyl chloride. By way of selection of the manufacturing process of distribution the respective thermoplastic and/or a component or mixture thereof, for example in a batch process, may be used with its material-specific property to set the required properties for the respective composite molding. Moreover, a mixture of different thermoplastic materials in a homogeneous and/or locally differentiated distribution of different thermoplastic materials may be advantageous. For example, a first number of composite moldings and a second number of composite moldings may be employed to represent a single sandwich component and/or a rotor-blade element, or a first number of composite moldings and a second number of composite moldings may be employed to represent a first and a second sandwich component and/or rotor-blade element which are installed in a rotor blade, a tower, a nacelle, and/or a rotor hub as a core component; the first and second number of composite moldings may have different core materials and/or braided formation-type fiber systems.

In a refinement a flexible, braided formation-type fiber system may have at least one component from the group composed of glass fibers, carbon fibers, aram id fibers, natural fibers, metallic yarns, monofilament or multifilament threads, in particular thermoplastic threads or, which in general, have polymer threads from nylon, PET, polypropylene or similar. A selection of a single fiber or a combination of fibers with one or a plurality of different rigidities may be used to specifically influence properties of the composite molding and/or to facilitate a materially-integral connection to the core material. Comparatively high melting points of the materials, in particular of the plastic materials, at or above 200° C. and UV resistance are advantageous.

Reinforcement of the thermoplastic material by way of additional, functionally oriented internal fibers proves advantageous. This and similar measures may be additionally employed for strengthening the composite molding. Corresponding effective mechanisms and/or calculated force moments of the fibers—such as, for example, glass fibers and/or carbon fibers—may be used, but also a three-dimensional, braided formation-type fiber system which correspondingly distributes itself in the thermoplastic material. These items may have a specific orientation and may be integrated in a manner corresponding to the manufacturing process.

A three-dimensional, braided formation-type fiber system is understood to be a braided formation-type fiber system of which the two-dimensional surface is three-dimensionally cross-linked by way of a braiding, warp-knitting, knitting or otherwise loop-forming or similar braided formation-type attachment of additional fibers, in particular the uniform distribution of braided formation-type fibers, in particular across an open cross section of a braided tube or fabric tube. To this extent, a three-dimensional, braided formation-type fiber system is to be differentiated from a two-dimensional, braided formation-type fiber system which may be planar, tubular, in particular in the shape of a braided tube or fabric tube—having round or square or rounded-square tubular cross-sectional shapes—or curved, entirely or partially openly curved and which may be used in combination with additional loosely interspersed fibers.

### BRIEF DESCRIPTION OF THE SEVERAL VIEWS OF THE DRAWINGS

Exemplary embodiments of the invention will now be described below in comparison to the prior art, which is, for example, likewise illustrated, by means of the drawing. These drawings are not necessarily intended to illustrate the exemplary embodiments true to scale; the drawing rather implements the exemplary embodiments in a schematic and/or slightly distorted manner wherever explanations are helpful. With respect to additions to the teachings which are directly obvious from the drawing, reference is made to the relevant prior art. It should be considered here that manifold modifications or alterations in relation to the shape and the detail of an embodiment may be performed, without departing from the general concept of the invention. The features of the invention which are disclosed in the description, in the drawing and in the claims may be substantial to the refinement of the invention individually as well as in any arbitrary combination. Moreover, all combinations of at least two features which are disclosed in the description, the drawing and/or the claims lie within the scope of the invention. The general concept of the invention is not limited to the exact shape or to the detail of the embodiment shown and described in the following, or limited to a subject matter which would be limited in comparison to the subject matter claimed in the claims. Ranges of dimensioning stated are to be disclosed here also as values lying within the mentioned limitations, i.e. as limit values, and to be able to be employed and claimed in an arbitrary manner. Further advantages, features and details of the invention may be obtained from the following description of the preferred exemplary embodiments and by means of the drawings.

In the drawings:

FIG. 1A shows a schematic illustration of an embodiment of a composite molding, wherein the thermoplastic material here is illustrated as a rectangular block having a preferred flexible braided formation;

FIG. 1B shows a schematic illustration of a further embodiment of a composite molding, wherein the thermoplastic material is illustrated as a cylindrical formation which is surrounded by a sock-type braided formation;

FIG. 2 shows a schematic illustration of the load acting on an upper functional layer, in the shape of a braided formation, of a composite molding;

FIG. 3A shows a schematic cross section of a composite molding in yet another preferred embodiment, wherein the shape-imparting core is illustrated as a thermoplastic material and the outer functional layer lying thereabove is illustrated as a flexible braided formation;

FIG. 3B shows a schematic cross section of a composite molding in yet another preferred embodiment, wherein the shape-imparting core is illustrated as a thermoplastic material and the outer functional layer lying thereabove, as a flexible braided formation, has the shape of a tube with a three-dimensional braided structure;

FIG. 3C shows a schematic cross section of a composite molding in yet another preferred embodiment, having integrated, functionally oriented fibers;

FIG. 4A shows a simplified cross-sectional illustration of a rotor blade of a wind-energy installation, having a composite molding according to a preferred embodiment;

FIG. 4B shows a cross-sectional illustration of a portion of a support structure of FIG. 4A;

FIG. 5 shows a wind-energy installation;

FIG. 6 shows a process diagram of a preferred embodiment of a manufacturing method.

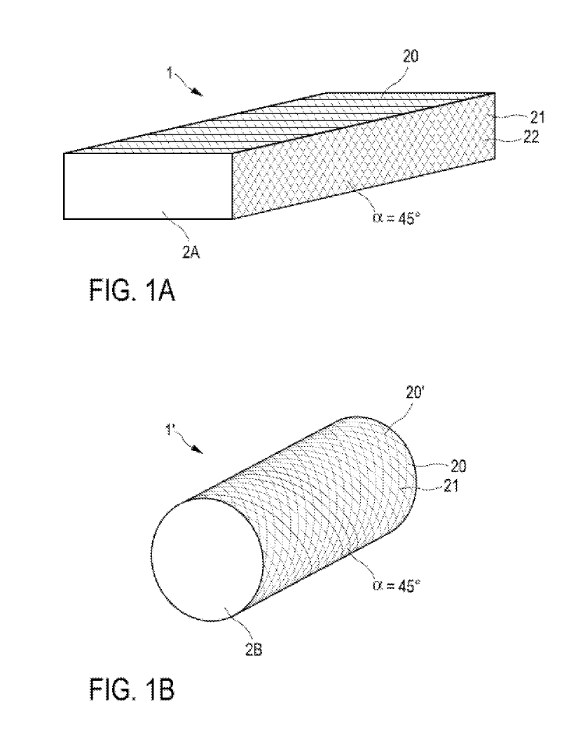

For the sake of simplicity, in FIGS. 1 to 4 the same reference signs are used for identical or similar parts or for parts having identical or similar functions.

### DETAILED DESCRIPTION

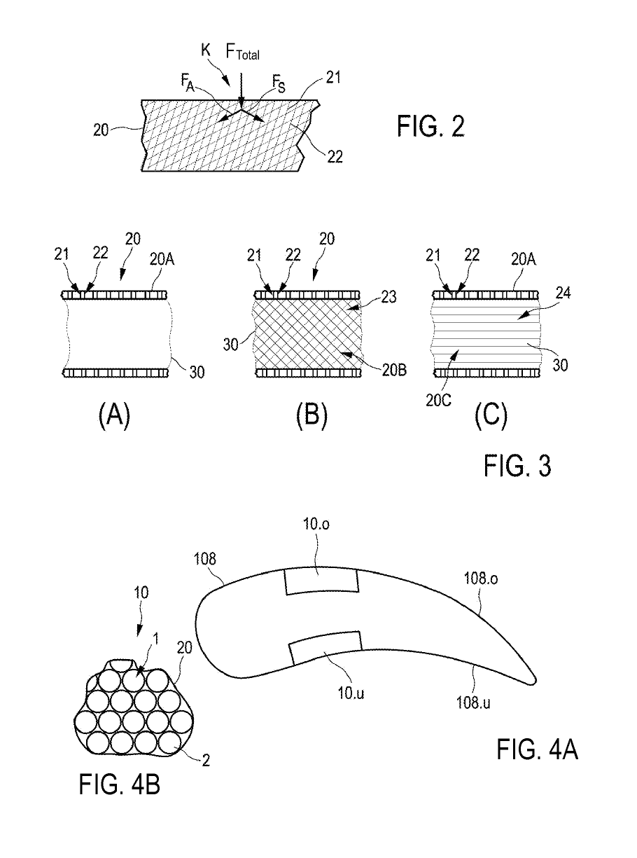

FIG. 1 shows a composite molding 1 which is illustrated in the shape of a rectangular block as a shape-imparting core material 2A. Here, the braided formation 20, being in this case a braided mat from glass fibers that is closed to form an outer covering of the rectangular block, encloses this rectangular block and shows fibers oriented in relation to one another at the functional fiber angle α of 45°. The individual fibers 21 and fibers 22 here show the fiber angle α=45° and, on the surface, form a functional parallelogram of forces which is explained in more detail with reference to FIG. 2. Here, a uniform distribution of the fibers is given in this illustration. However, it would also be conceivable for the fibers 21, 22 to be expanded in a different manner, depending on a distribution of stress, for example. In this manner, a functional orientation in braided structures which are locally denser could be effected in regions where a higher load acts, too. The shape of the thermoplastic material may already serve in a facilitating manner as a shape-imparting core material. By way of the selection of the braided structures and the density thereof, centers or general regions of comparatively high acting forces may also be reinforced.

FIG. 1B, in an analogous manner, shows a composite molding 1′ of another embodiment; in this case the shape-imparting thermoplastic material 2B has been illustrated in the shape of a cylinder which is surrounded by a flexible braided formation 20′; in this case, the latter is a braided tube from PET. The oriented fibers here correspond to the angle of 45° mentioned in claim 1 and are thus functionally oriented in relation to one another in order to thus represent an outer functional layer.

In FIG. 2 an external effective force F_{Total}—in this case a tensile force—with the resulting normal forces F_{A} and F_{S} which are divided in a parallelogram of forces K is schematically illustrated. The oriented fibers 21, and 22, as an outer functional layer, here counteract the normal forces and, in the plane, form a functional layer which counteracts the force. The fibers of the braided formation can counteract the force F_{Total}, acting thereon, with an increased strength of the composite system, without a fiber 21 being able to yield to transverse stress, since the latter is absorbed by the fiber 22. Further shear forces or transfer forces may also be contained here by the outer functional layer and be minimized in the composite molding having corresponding material-specific properties.

FIG. 3A, in a cross section, schematically shows a composite molding in which the outer layer 20A of a two-dimensional structure of a braided formation-type fiber system is illustrated, in this case having an oriented braided formation 20 from threads 21 and 22 and a material core from thermoplastic material 30.

In FIG. 3B a three-dimensional orientation of a braided formation-type fiber system is illustrated which, apart from the outer functional layer 20A, is also oriented internally with threads 23 of one of the shape-imparting core materials 30 and thus forms a three-dimensional effective structure 20B against external load effects.

In FIG. 3C longitudinal fibers 24 in the interior of the core of thermoplastic material 30 are illustrated, said longitudinal fibers, in addition to the outer functional layer 20A having the fibers 21, 22 at the angle of 45°, representing a fiber combination 20C as a protection against external load effects and being able to absorb additional shear tensions and torsion tensions.

In FIG. 4A a rotor blade 108 for a wind-energy installation 100 is illustrated in a simplified manner in the cross section. This rotor blade 108 comprises an upper half-shell 108.o and a lower half-shell 108.u, wherein support structures 10.o and 10.u which can absorb and transfer the loads acting on the rotor blade are provided in these shells. These support structures may be configured by rotor-blade elements, for example in a sandwich-construction technique, and/or by said composite moldings in order to absorb precisely these corresponding loads. FIG. 4B shows such a support structure 10 having a multiplicity of composite moldings 1, having a core material 2 surrounded by a flexible, braided formation-type fiber system 20 of FIGS. 1A-3C, which, here in an exemplary manner, are assembled in the tightest packing to form the support structure 10.

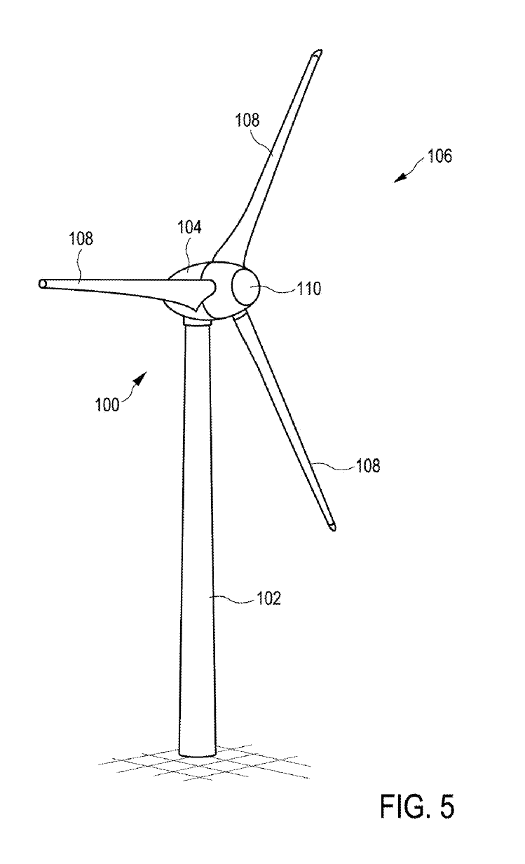

FIG. 5 shows a wind-energy installation 100 with a tower 102 and a nacelle 104. A rotor 106, having three rotor blades 108—such as in an analogous manner to a rotor blade 108 of FIG. 4—and a spinner 110, is disposed on the nacelle 104. During operation the rotor 106 is set in rotating motion by the wind and, on account thereof, drives a generator in the nacelle 104.

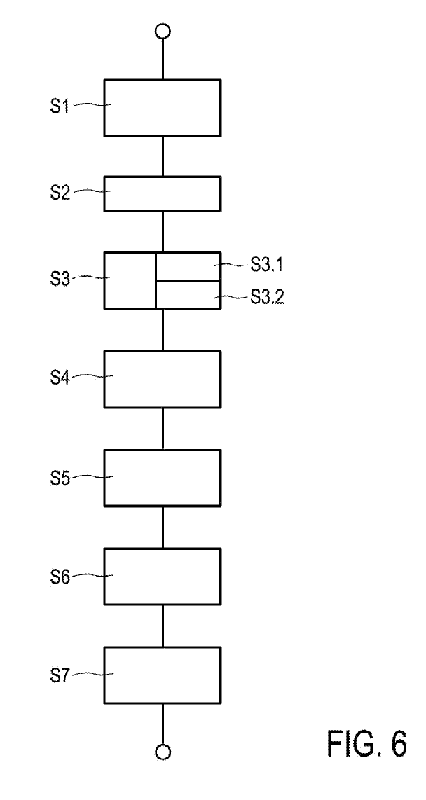

FIG. 6, in the context of a flow diagram, shows a preferred embodiment of a manufacturing method for a composite molding 1 and/or the assembly of a multiplicity thereof to form a support structure 10 for introduction into a rotor blade 108 of a wind-energy installation 100. In a first step S1 a thermoplastic material is provided, and in a step S2 a fiber-composite semi-finished product in the shape of a braided formation of the type explained above is provided.

In a third step S3 the thermoplastic material as a shape-imparting core material is introduced into the flexible braided formation and distributed therein, such that the former connects to the braided formation. In the present case, in a step S3.1, the thermoplastic material from a mixture of granulates is fed to an extruder and, in a step S3.2, at the output end of the extruder, directly introduced as a soft strand into a braided tube. The braided tube has mutually intersecting fibers which, at an intersection point, have a fiber angle of 45°, and the former contracts about the still soft, shape-imparting core material when the latter cools. On account thereof, the soft, shape-imparting material solidifies around or on the braided tube and/or on the fibers thereof, such that a composite is created between the braided tube and the thermoplastic material, said composite in relation to the braided formation optionally being complete or, in any case, partial, but not necessarily on the outer side thereof; the soft, shape-imparting material may remain within the contours of the braided tube or also completely or partially penetrate outwards through the braiding, that is to say, in the latter case ooze out and, if applicable, spread around the outside of the braided tube again and enclose the latter.

The composite strand which is entirely producible as a continuous strand, in step S4, may be divided according to requirements into a multiplicity of composite moldings and, in a step S5, may assembled, such as in the manner shown in the detail X of FIG. 4, to form a support structure. The support structure, in a step S6, may be introduced into a half-shell of a rotor blade 108 or into another part of a wind-energy installation 100. In the present case the half-shells are assembled to form a rotor-blade blank and subjected to the further processing steps until the rotor blade, in a step S7, can be attached on a wind-energy installation 100 of the type shown in FIG. 5

1. A method comprising:
manufacturing a composite molding for a wind-energy installation, the composite molding having a thermoplastic material and a fiber-composite semi-finished product, wherein manufacturing includes:
distributing the thermoplastic material as a shape-imparting core material in the flexible, braided formation-type fiber system of the fiber-composite semi-finished product, and
connecting the thermoplastic material to the braided formation-type fiber system, wherein:
the flexible, braided formation-type fiber system with the shape-imparting core material has mutually intersecting fibers that orient themselves in relation to one another,
the intersecting fibers, at an intersection point, have a fiber angle that is between 10° and 90°, and
the flexible, braided formation-type fiber system forms the outer functional layer of the composite molding.

2. The method according to claim 1, wherein:
the thermoplastic material is made available as a strand from an extruder, and
the flexible, braided formation-type fiber system is made available as a tubular, braided formation-type fiber system,
the thermoplastic material, as a shape-imparting core material, is distributed in the flexible, braided formation-type fiber system of the fiber-composite semi-finished product and is introduced as a soft strand into the tube of the braided formation-type fiber system, and
said thermoplastic material, as an outer functional layer of the composite molding, while solidifying the soft strand, forms a composite with the braided formation-type fiber system.

3. The method according to claim 1, wherein the thermoplastic material distributes in the flexible, braided formation-type fiber system of the fiber-composite semi-finished product and connects in a materially-integral manner to the flexible, braided formation-type fiber system.

4. The method according to claim 1, wherein the thermoplastic material distributes in the flexible, braided formation-type fiber system of the fiber-composite semi-finished product and connects in a form-fitting manner to the flexible, braided formation-type fiber system.

5. The method according to claim 1, wherein additional fibers are introduced into at least one of the braided formation-type fiber system and the thermoplastic material independently of the fiber angle, and increase the strength of the composite molding in comparison with a composite molding without the additional fibers.

6. A composite molding for a wind-energy installation, the composite molding comprising:
a thermoplastic material and a fiber-composite semi-finished product, wherein:
the fiber-composite semi-finished product has a flexible, braided formation-type fiber system,
the thermoplastic material, as a shape-imparting core material, is distributed in the flexible, braided formation-type fiber system of the fiber-composite semi-finished product and is connected to the braided formation-type fiber system, wherein:
the braided formation-type fiber system, in the composite with the shape-imparting core material, has mutually intersecting fibers that are oriented in relation to one another,
the fibers, in an intersection point, have a fiber angle which is between 10° and 90°, and
the braided formation-type fiber system in the composite forms the outer functional layer of the composite molding.

7. The composite molding according to claim 6, wherein the braided formation-type fiber system is a fiber system selected from the group composed of braidwork, knits, warp knits, and fabrics.

8. The composite molding according to claim 6, wherein the thermoplastic material is a strand and the flexible, braided formation-type fiber system is a tubular, braided formation-type fiber system, the braided formation-type fiber system shaped as a tube with a two-dimensionally oriented braided formation.

9. The composite molding according to claim 6, wherein the braided formation-type fiber system is shaped as a tube with a three-dimensional braided structure and additional fibers in the interior of the composite are functionally oriented in relation to one another having a fiber angle of between 15° and 90°.

10. The composite molding according to claim 6, wherein the thermoplastic material is reinforced by additional internal, functionally oriented fibers.

11. The composite molding according to claim 6, wherein the thermoplastic material distributed in the flexible, braided formation-type fiber system has at least one component from the group of acrylonitrile butadiene styrene, polyamide, polyacetate, polymethyl methacrylate, polycarbonate, polyethylene terephthalate, polyethylene, polypropylene, polystyrene, polyether ether ketone and polyvinyl chloride.

12. The composite molding according to claim 6, wherein the flexible, braided formation-type fiber system has a braided component selected from the group of braiding components having glass fibers, carbon fibers, aramid fibers, natural fibers, metallic yarns, monofilaments and thermoplastic threads.

13. A sandwich component for a wind-energy installation, comprising:
a plurality of composite moldings according to claim 6 for forming a core component, wherein the core component is at least on one side covered by at least one cover layer.

14. A rotor-blade element for a rotor blade of a wind-energy installation, comprising:
a plurality of composite moldings according to claim 6 for forming a core component, wherein the core component is surrounded by at least one rotor-blade cover layer.

15. A wind-energy installation comprising:
a tower,
a nacelle, and
a rotor with a rotor hub and a plurality of rotor blades, wherein a portion of at least one of the rotor blades, the tower, the nacelle and the rotor hub have a composite molding including:
a thermoplastic material and a fiber-composite semi-finished product, wherein:
the fiber-composite semi-finished product has a flexible, braided formation-type fiber system,
the thermoplastic material, as a shape-imparting core material, is distributed in the flexible, braided formation-type fiber system of the fiber-composite semi-finished product and is connected to the braided formation-type fiber system, wherein:
the braided formation-type fiber system, in the composite with the shape-imparting core material, has mutually intersecting fibers that are oriented in relation to one another,
the fibers, in an intersection point, have a fiber angle that is between 10° and 90°, and
the braided formation-type fiber system in the composite forms the outer functional layer of the composite molding.

16. The method according to claim 1, wherein the fiber angle is between 30° and 60°.

17. The method according to claim 16, wherein the fiber angle is around 45° with a variance range of +/−5°.

18. The composite molding according to claim 6, wherein the fiber angle is between 30° and 60°.

19. The composite molding according to claim 18, wherein the fiber angle is around 45° with a variance range of +/−5°.
